(19) United States
(12) Patent Application Publication
(10) Pub. No.: US 2007/0239924 A1
(43) Pub. Date: Oct. 11, 2007

(54) Electronic device transmitting audio-and-video signals with USB connector

(76) Inventors: Toon-Jeow Foo, Taipei (TW); Steel Su, Taipei (TW); Hsing-Liang Lin, Taipei (TW)

Correspondence Address: BACON & THOMAS, PLLC, 625 SLATERS LANE, FOURTH FLOOR, ALEXANDRIA, VA, 22314, US

(21) Appl. No.: 11/390,089

(22) Filed: Mar. 28, 2006

(51) Int. Cl. G06F 13/00

(52) U.S. Cl. 710/316

(57) ABSTRACT

The present invention relates to an electronic device that transmits audio-and-video (AV) signals with a universal serial bus (USB) connector, comprising a USB on-the-go (OTG) connector, a USB OTG controller, and a signal switch. The signal switch includes an AV signal end receiving an AV signal, a USB data signal end connected to a USB data signal port of the USB OTG controller, a USB/AV signal end connected to a data signal terminal of the USB OTG connector, and a switch signal end receiving a switch signal. Alternatively, the signal switch switches and connects the USB/AV signal end to the AV signal end, or switches and connects the USB/AV signal end to the USB data signal end, according to the switch signal.

### FIELD OF THE INVENTION

The present invention relates to an electronic device with a universal serial bus (USB) interface, and more particularly, to an electronic device equipped with a USB interface, transmitting USB signals and audio-and-video (AV) signals with the USB connector, and identifies an operation mode automatically to determine the transmission mode of the USB connector.

### BACKGROUND OF THE INVENTION

As regards any known electronic device with a USB interface, whether it is a conventional USB interface with four terminals or a USB interface with five terminals under the USB on-the-go (OTG) standard; the USB interface is only to transmit USB signals. Therefore, it is necessary to use an extra connector when the audio signals transmitted by any conventional electronic devices, for example, a MP3 player with a USB interface is not only equipped with a USB connector but also equipped with a headphone jack. This shows that the known electronic devices still rely upon a conventional audio connector, such as a headphone jack, for transmitting the analog voice signals produced.

In order to overcome the disadvantage of the prior art, the inventor of the present invention provides an electronic device having a USB interface transmits USB and AV signals with the data signal terminal of the USB connector.

### SUMMARY OF THE INVENTION

Accordingly, an object of the present invention is to provide an electronic device transmits USB signals and AV signals with its USB connector and identifies an operation mode automatically in order to determine the transmission mode of the USB connector.

To achieve the above object, the present invention provides an electronic device that transmits AV signals with a USB connector; the electronic device comprises a USB OTG connector, a USB OTG controller, and a signal switch. The signal switch comprises an AV signal end receiving AV signals, a USB data signal end connected to the USB data signal port of the USB OTG controller, a USB AV signal end connected to the data signal terminal of the USB OTG connector, and a switch signal end receiving switch signals. The signal switch switches the USB AV signal end to either the AV signal end or the USB data signal end in accordance with the switch signals.

For a further understanding of the nature and advance of the invention, reference should be made to the following description in conjunction with the accompanying drawings.

### BRIEF DESCRIPTION OF THE DRAWINGS

The object and other objects and advantages of the present invention will become more apparent upon reading of the following detailed description and the accompanying drawings in which:

FIG. 1 is a circuit diagram showing the electronic device of the first embodiment that transmits AV signals with a USB connector;

FIGS. 2A-2D are schematic block diagrams respectively illustrating the connection electronic devices with the first embodiment of the present invention;

FIG. 3 is a flow diagram corresponding to program codes of the electronic device in accordance with the present invention;

FIG. 4 is a circuit diagram showing the electronic device of the second embodiment that transmits AV signals with a USB connector;

FIGS. 5A-5C are schematic block diagrams illustrating the connection electronic devices with the second embodiment of the present invention respectively;

FIG. 6 is a circuit diagram showing the electronic device of the third embodiment that transmits AV signals with a USB connector;

FIGS. 7A and 7B are schematic block diagrams illustrating the connection electronic devices with the third embodiment of the present invention respectively;

FIG. 8 illustrates a preferred implementation of signals switch of the present invention; and

FIG. 9 illustrates another preferred implementation by the signal switch of the present invention.

### DETAILED DESCRIPTION OF THE INVENTION

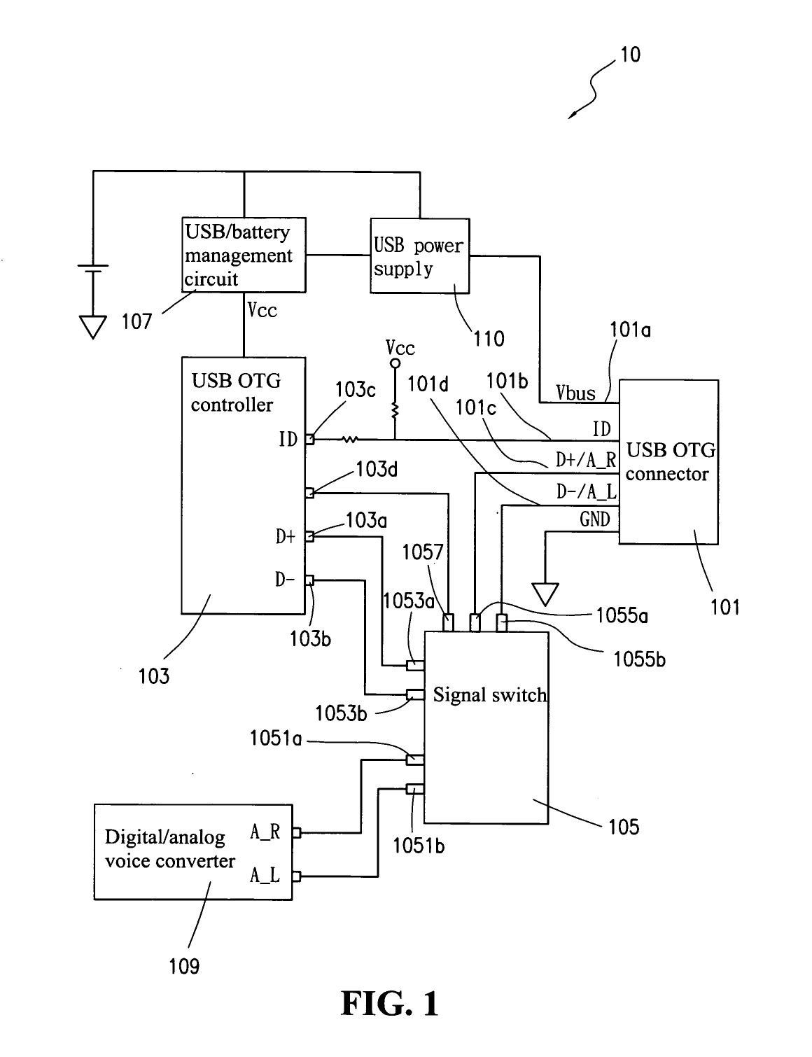

Referring to FIGS. 1, 4 and 6, an electronic device 10 of the present invention transmits AV signals with its USB connector which also serves to transmit USB signals. In practice, both the AV signals and the USB signals are transmitted, using a USB connector shared. When a user connects a USB OTG connector 101 (or a USB connector 101) of the electronic device 10 to a corresponding USB connector of the electronic device, such as a computer, a USB flash drive or a charger with an AV amplifier, the electronic device 10 automatically detects the connection mode of the USB OTG connector 101 (or the USB connector 101) and determines whether it serves to transmit AV signals or USB signals. Hence, it is not necessary for the electronic device 10 of the present invention to be specially equipped with a second connector to transmit AV signals.

FIG. 1 is a circuit diagram showing the electronic device that transmits AV signals with a USB connector in the first embodiment. The electronic device 10 comprises at least a USB OTG connector 101, a USB OTG controller 103, and a signal switch 105. Wherein the USB OTG connector 101 can be a USB OTG mini-AB connector, with a Vbus terminal 101a connected to a USB power supply 110. A USB/battery management circuit 107 is connected to the USB power supply 110 and the USB OTG controller 103 respectively. An identification (ID) terminal 101b of the USB OTG connector 101 is electronically connected to an identification signal port 103c of the USB OTG controller 103. The signal switch 105 can be a multiplexer and receives AV signals through AV signal ends 1051a and 1051b; the AV signals are generated by a digital/analog voice converter 109 connected to the AV signal ends 1051a and 1051b of the signal switch 105. USB data signal ends 1053a and 1053b of the signal switch 105 are connected to USB data signal ports 103a and 103b of the USB OTG controller 103 respectively. USB/AV signal ends 1055a and 1055b of the signal switch 105 are connected to data signal terminals 101c and 101d of the USB OTG connector 101. A switch signal end 1057 of the signal switch 105 receives a switch signal, alternatively switches and connects the USB/AV signal ends 1055a and 1055b to the AV signal ends 1051a and 1051b or to the USB data signal ends 1053a and 1053b, according to the switch signal. The switch signal end 1057 is connected to a switch signal port 103d of the USB OTG controller 103.

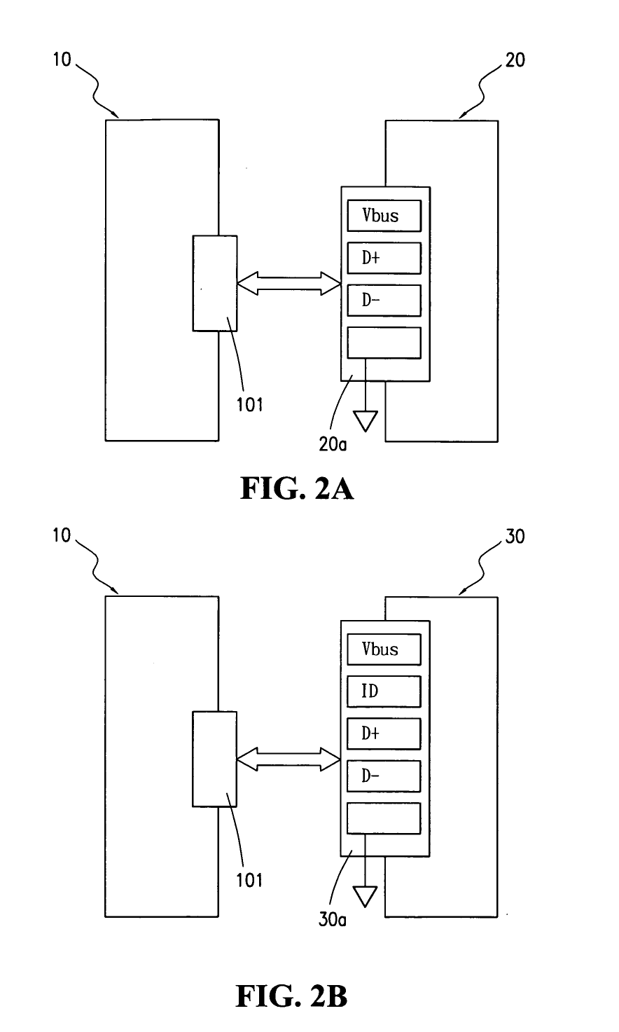

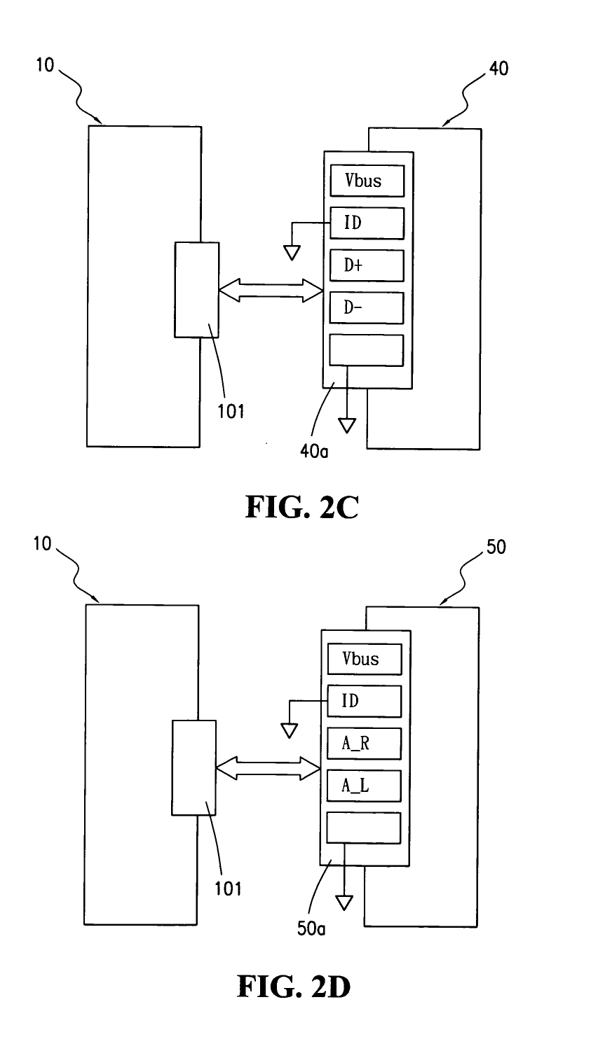

Referring to FIGS. 2A-2D, respectively illustrating the connection of electronic devices and the first embodiment of the present invention. In FIG. 2A, the electronic device 20 is a USB slave device, such as a card reader, a digital camera or a cell phone, and is equipped with a 4-terminal USB connector 20a. In FIG. 2B, the electronic device 30 is a USB slave device and is equipped with a 5-terminal USB OTG connector 30a, such as a USB OTG mini-B plug. When the electronic device 10 of the present invention is connected to the electronic device 20 or 30, the signal received by the identification signal port 103c of the USB OTG connector 101 is a high-level identification signal; accordingly, the USB OTG controller 103 generates a high-level switch signal which is then sent to the switch signal end 1057 through the switch signal port 103d to make the signal switch 105 electronically connect the USB data signal ports 103a and 103b, the USB data signal ends 1053a and 1053b, the USB/AV signal ends 1055a and 1055b, and the data signal terminals 101c and 101d.

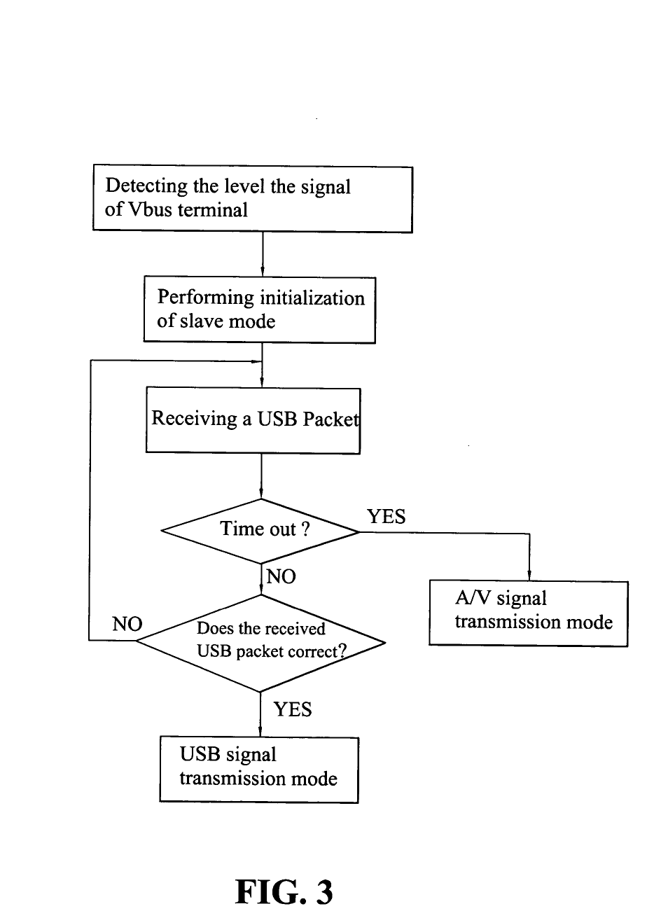

In FIG. 2C, the electronic device 40 is a USB host device, such as a computer, and configured with a 5-terminal USB OTG connector 40a. In FIG. 2D, the electronic device 50 is equipped with a 5-terminal USB OTG connector 40a, but the electronic device 50 is a car charging kit, a FM transmitter or a docking unit, into which an AV amplifier is integrated, rather than a USB standard electronic device. When the electronic device 10 of the present invention is connected to the electronic device 40 or 50, the signal received by the identification signal port 103c of the USB OTG controller 103 is a low-level identification signal; therefore, as described in FIG. 3, the USB OTG controller 103 executes program codes right away. The USB OTG controller 103 detects a high-level signal sent by the electronic device 40 or 50 via the Vbus terminal 101a, and the USB OTG controller 103 performs the initialization of the slave mode to configure the electronic device 10 to function as a USB slave device. Afterward, the USB OTG controller 103 detects and determines whether has received a USB packet sent by the electronic device 40 or 50 via the data signal terminals 101c and 101d within a predetermined period (for example, within five seconds). Under such conditions, the USB packet only sent by the electronic device 40. Upon receipt of a USB packet, the USB OTG controller 103 generates a high-level switch signal which is then sent to the switch signal end 1057 via the switch signal port 103d to make the signal switch 105 electronically connect the USB data signal ports 103a and 103b, the USB data signal ends 1053a and 1053b, the USB/AV signal ends 1055a and 1055b, and the data signal terminals 101c and 101d; and the above-mentioned is the description of the USB signal transmission mode in FIG. 3. Of course, if the USB OTG controller 103 does not receive any USB packet, then the USB OTG controller 103 generates a low-level switch signal which is then sent to the switch signal end 1055 via the switch signal port 103d to make the signal switch 105 electronically connect the voice output end of the digital/analog voice converter 109, the AV signal ends 1051a and 1051b, the USB/AV signal end 1055a and 1055b, and the data signal terminal 101c and 101d; and the above-mentioned is the description of the AV signal transmission mode in FIG. 3.

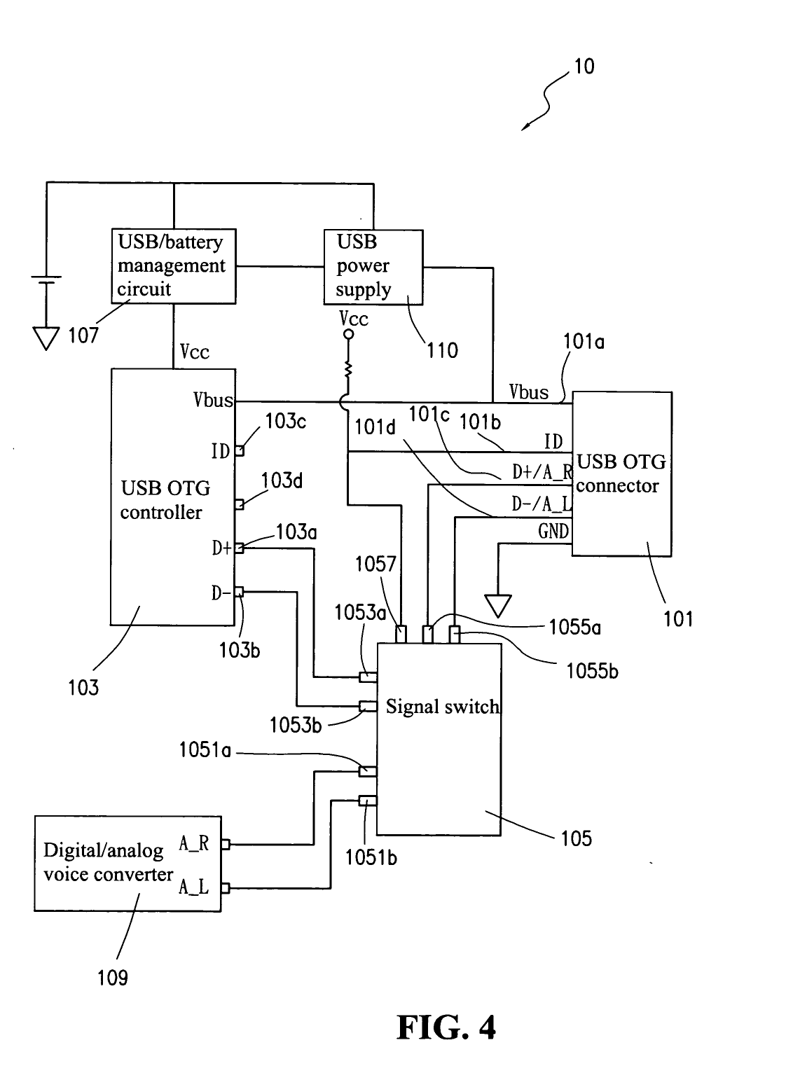

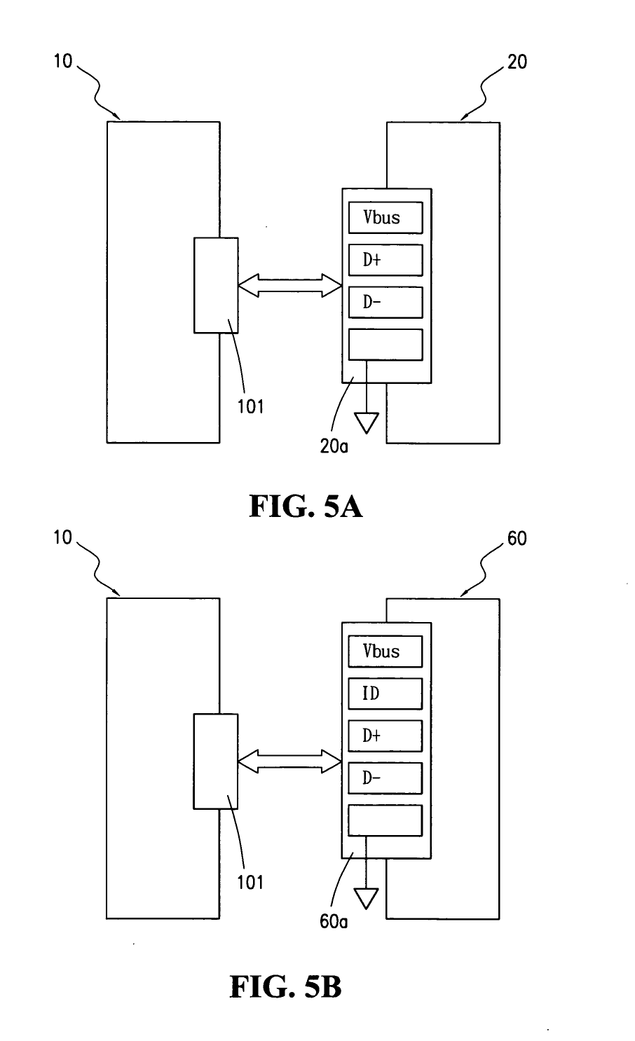

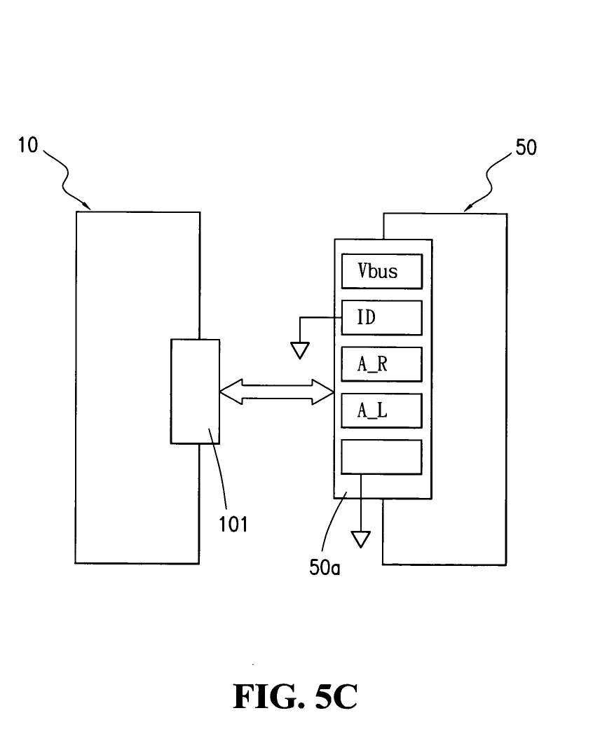

FIG. 4 is a circuit diagram showing an electronic device that transmits AV signals with a USB connector in the second embodiment, whereas FIGS. 5A-5C are schematic block diagrams illustrating the connection of electronic devices and the second embodiment of the present invention respectively. In FIG. 4, both the identification signal port 103c and the switch signal port 103d of the USB OTG controller 103 are at an idle state, wherein the identification (ID) terminal 101b of the USB OTG connector 101 is connected to the switch signal end 1055. Alternatively, the signal switch 105 of the second embodiment switches and connects the USB/AV signal ends 1055a and 1055b to the AV signal ends 1051a and 1051b, or it switches and connects the USB/AV signal ends 1055a and 1055b to the USB data signal ends 1053a and 1053b, according to the signal level of the identification (ID) terminal 101b of the USB OTG connector 101.

In FIG. 5A, the electronic device 20 is identical to the electronic device shown in FIG. 2A, that is, a USB slave device. In FIG. 5B, the electronic device 60 is a USB host device, such as a computer, and it is equipped with a 4-terminal USB connector 60a. After the electronic device 10 of the second embodiment is connected to the electronic devices 20 and 60, the signal of the identification (ID) terminal 101b of the USB OTG connector 101 being of a high level, the signal switch 105 switches the high-level signal and electronically connects the USB data signal ports 103a, 103b, the USB data signal ends 1053a and 1053b, the USB/AV signal ends 1055a and 1055b, and the data signal terminals 101c and 101d directly. The USB controller 103 detects the level of a signal sent by the electronic devices 20 and 60 via the Vbus terminal 101a. In case of a high-level Vbus signal, which indicates that the electronic device 10 is connected to the electronic device 60, the electronic device 10 will configure itself to function as a USB slave device. In case of a low-level Vbus signal, which indicates that the electronic device 10 is connected to the electronic device 20, the electronic device 10 will configure itself to function as a USB host device.

In FIG. 5C, the electronic device 50 is the same electronic device shown in FIG. 2D. Since the level of the voltage of the identification (ID) terminal 501 of the USB connector 50a is low, the signal of the identification (ID) terminal 101b of the USB OTG connector 101 is turned into a low-level identification signal. As a result, the signal switch 105 switches the high-level signal and electronically connects the voice output end of the digital/analog voice converter 109, the AV signal ends 1051a and 1051b, the USB/AV signal ends 1055a and 1055b, and the data signal terminals 101c and 101d directly.

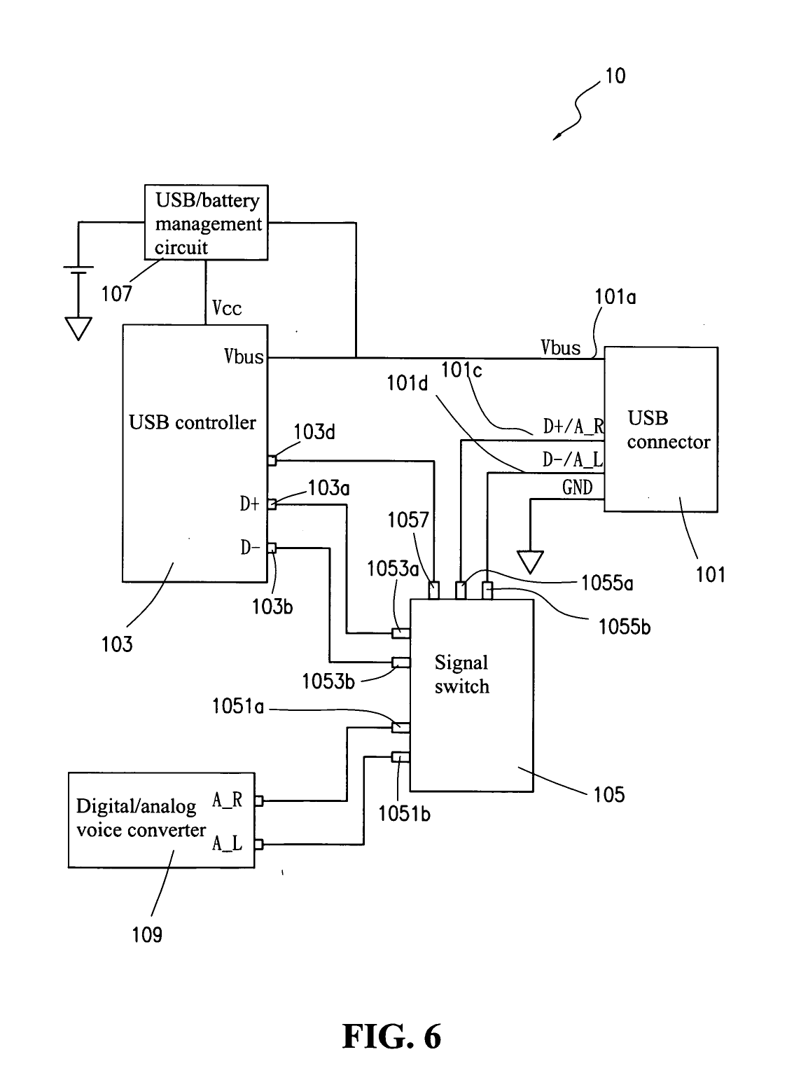

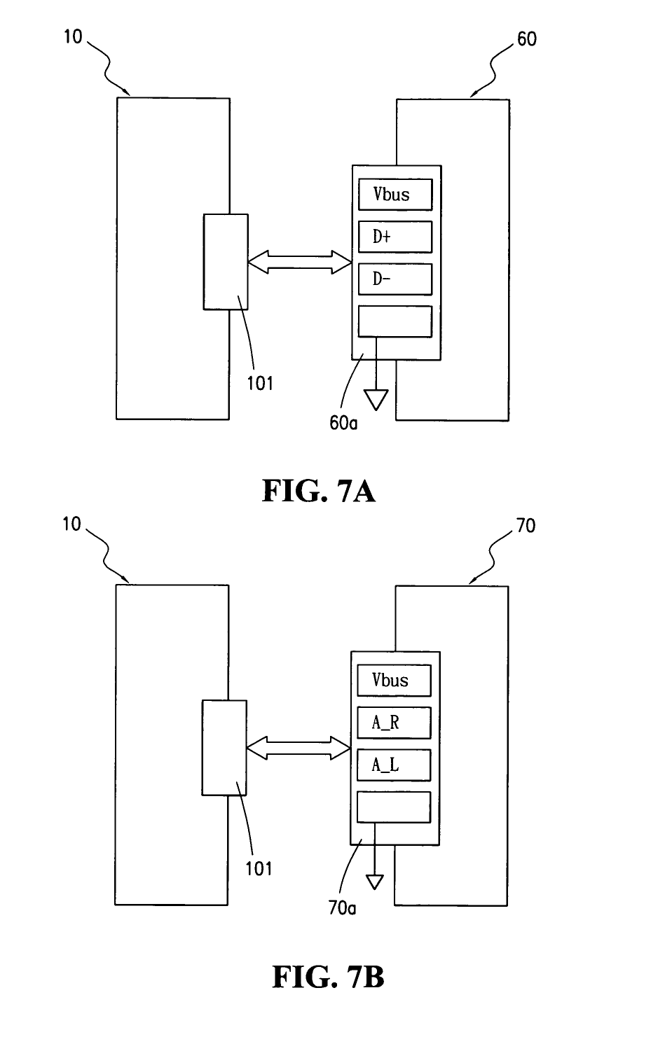

FIG. 6 is a circuit diagram showing the third embodiment of the electronic device that transmits AV signals with a USB connector in accordance with the present invention, and FIGS. 7A and 7B are schematic block diagrams illustrating the connection of electronic devices and the third embodiment of the present invention respectively. Unlike its counterparts in the first and the second embodiments where a USB OTG connector is used, the electronic device 10 of the third embodiment uses a USB connector equipped with four signal terminals 101. In addition, the electronic device 10 of the third embodiment uses a USB controller 103 having a USB slave port, whereas its counterparts in the first and the second embodiments use a USB OTG controller. In FIG. 7A, the electronic device 60 is the same electronic device shown in FIG. 5B. In FIG. 7B, the electronic device 70 is equipped with a 4-terminal USB connector 70a, and the electronic device 70 is a car charging kit, a FM transmitter or a docking unit rather than an electronic device of USB standard. In the third embodiment, the USB controller 103 generates a switch signal to be sent to the signal switch 105 via the switch signal port 103d and the switch signal end 1057.

In the third embodiment, the USB controller 103 executes program codes having the same process shown in FIG. 3. The USB controller 103 detects a high-level signal sent by the electronic device 60 or 70 via the Vbus terminal 101a, then the USB controller 103 performs the initialization of the slave mode in order to configure the electronic device 10 to function as a USB slave device. Afterward, within a predetermined period of time (for example, within five seconds), the USB controller 103 detects and determines whether it has received a USB packet sent by the electronic device 60 or 70 via the data signal terminals 101c and 101d. Under such a situation, only the electronic device 60 may send a USB packet. Upon receipt of a USB packet, the USB controller 103 generates a high-level switch signal which is then sent to the switch signal end 1057 via the switch signal port 103d to make the signal switch 105 electronically connect the USB data signal ports 103a and 103b, the USB data signal ends 1053a and 1053b, the USB/AV signal ends 1055a and 1055b, and the data signal terminals 101c and 101d. When there is no USB packet received by the USB controller 103, a low-level switch signal generated by USB controller 103 and sent to the switch signal end 1055 via the switch signal port 103d to make the signal switch 105 electronically connect the voice output end of the digital/analog voice converter 109, the AV signal ends 1051a and 1051b, the USB/AV signal end 1055a and 1055b, and the data signal terminal 101c and 101d.

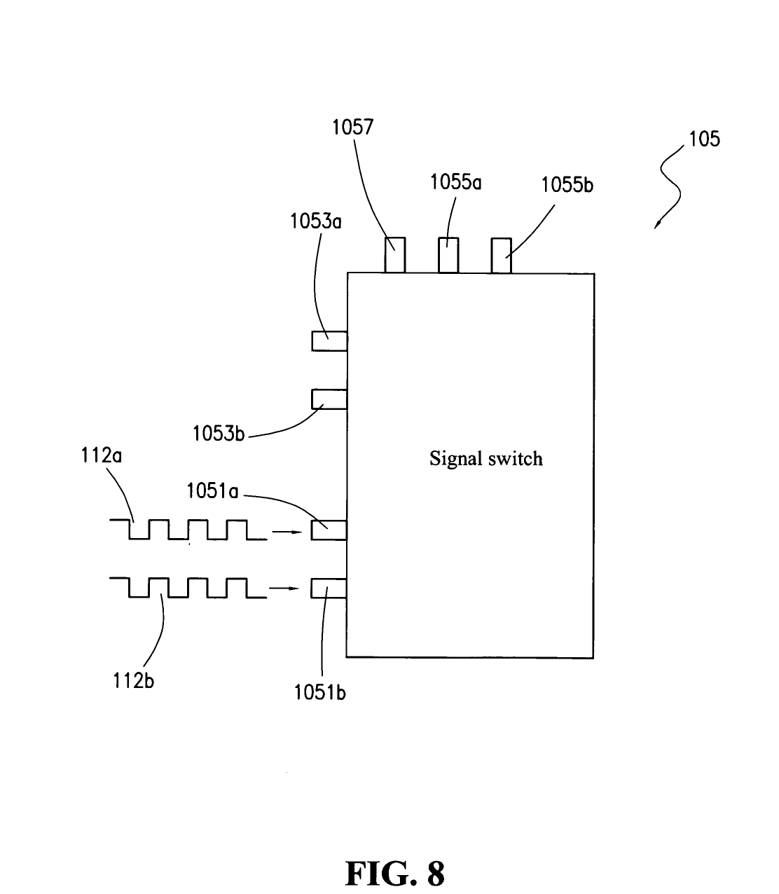

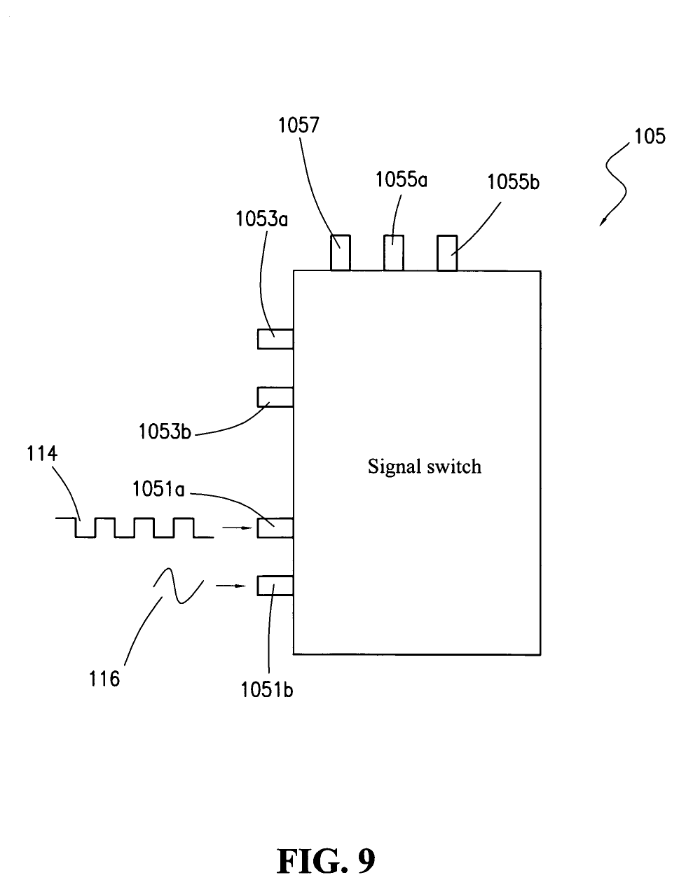

To sum up, the aforesaid first through third embodiments are illustrated by way of examples involving right channel analog signals and left channel analog signals, it is to be understood that the invention is not limited thereto. Moreover, FIG. 8 illustrates an embodiment of the variations in the types of signals switched to by a signal switch in accordance with the present invention. In FIG. 8, digital signals 112a and 112b can be alternatively, for example, a right channel digital signal and a left channel digital signal respectively, or an encoded digital AV signal. FIG. 9 illustrates another embodiment of the variations in the types of signals switched to by a signal switch in accordance with the present invention. In FIG. 9, a digital signal 114 can be, for example, a synthesized digital signal of the right and left channels, whereas a video signal 116 is either a dynamic movie signal or a static image signal.

The electronic device 10 of the present invention can be a voice player and an AV player like a MP3 player; also, the electronic device 10 can certainly be a portable electronic device that combines the functions of voice playing and AV playing, such as a palm-held MP3 player, a palm-held MPEG4 player, or a recording pen.

The electronic device 10 can identify an operation mode automatically to transmit USB signals and AV signals with a USB OTG connector (or USB connector). Accordingly, the connection of present invention is superior to the conventional electronic device equipped with a USB interface.

While the invention has been described by way of examples and in terms of preferred embodiments, it is to be understood that the invention is not limited thereto. To the contrary, it is intended to cover various modifications and similar arrangements and procedures, and the scope of the appended claims therefore should be according to the broadest interpretation so as to encompass all such modifications and similar arrangements and procedures.

What is claimed is:

1. An electronic device transmitting audio-and-video (AV) signals with a universal serial bus (USB) connector, comprising:
a USB on-the-go (OTG) connector;
a USB OTG controller; and
a signal switch, including:
an AV signal end for receiving an AV signal;
a USB data signal end connected to a USB data signal port of said USB OTG controller;
a USB/AV signal end connected to a data signal terminal of said USB OTG connector; and
a switch signal end for receiving a switch signal, wherein, alternatively, said signal switch switches and connects said USB/AV signal end to said AV signal end, or it switches and connects said USB/AV signal end to said USB data signal end, according to said switch signal.

2. The electronic device of claim 1, wherein an identification (ID) terminal of said USB OTG connector being electronically connected to an identification signal port of said USB OTG controller; and said USB OTG controller comprising a switch signal port connected to said switch signal end and intended to output said switch signal, wherein said switch signal is generated by said USB OTG controller.

3. The electronic device of claim 2, further comprising program codes to be executed by said USB OTG controller to determine whether said switch signal generated is a high-level switch signal or a low-level switch signal.

4. The electronic device of claim 1, wherein the identification (ID) terminal of said USB OTG connector being connected to said switch signal end, wherein, alternatively, said signal switch switches and connects said USB/AV signal end to said AV signal end, or switches and connects said USB/AV signal end to said USB data signal end and a signal of the identification (ID) terminal of said USB OTG connector, according to the signal of the identification (ID) terminal of said USB OTG connector.

5. The electronic device of claim 4, wherein a Vbus terminal of said USB connector being connected to said USB OTG controller.

6. The electronic device of claim 1, further comprising a digital/analog voice converter connected an AV signal end of said signal switch and intended to generate said AV signal.

7. The electronic device of claim 1, wherein said electronic device is a portable electronic device.

8. The electronic device of claim 1, wherein said electronic device is a voice player.

9. The electronic device of claim 1, wherein said electronic device is an AV player.

10. The electronic device of claim 1, wherein said signal switch is a multiplexer.

11. The electronic device of claim 1, wherein said AV signal including a right channel digital signal and a left channel digital signal.

12. The electronic device of claim 1, wherein said AV signal including a right channel analog signal and a left channel analog signal.

13. The electronic device of claim 1, wherein said AV signal including a synthesized digital signal of the right and left channels and a video signal.

14. An electronic device transmitting AV signals with a USB connector, comprising:
a USB connector equipped with four signal terminals;
a signal switch, including:
an AV signal end for receiving an AV signal;
a USB data signal end connected to a USB data signal port of said USB controller;
a USB/AV signal end connected to a data signal terminal of said USB connector;
a switch signal end for receiving a switch signal, wherein, alternatively, said signal switch switches and connects said USB/AV signal end to said AV signal end, or it switches and connects said USB/AV signal end to said USB data signal end, according to said switch signal; and
a USB controller, equipped with a USB slave port, including a switch signal port, connected to said switch signal end, and intended to output said switch signal, wherein said switch signal is generated by said USB controller.

15. The electronic device of claim 14, further comprising program codes to be executed by said USB controller to determine whether said switch signal generated is a high-level switch signal or a low-level switch signal.

16. The electronic device of claim 14, wherein a Vbus terminal of said USB connector connected to said USB controller.

17. The electronic device of claim 14, further comprising a digital/analog voice converter connected to an AV signal end of said signal switch and intended to generate said AV signal.

18. The electronic device of claim 14, wherein said electronic device is a portable electronic device.

19. The electronic device of claim 14, wherein said electronic device is a voice player.

20. The electronic device of claim 14, wherein said electronic device is an AV player.

21. The electronic device of claim 14, wherein said signal switch is a multiplexer.

22. The electronic device of claim 14, wherein said AV signal including a right channel digital signal and a left channel digital signal.

23. The electronic device of claim 14, wherein said AV signal including a right channel analog signal and a left channel analog signal.

24. The electronic device of claim 14, wherein said AV signal including a synthesized digital signal of the right and left channels and a video signal.
